(19) United States
(12) Patent Application Publication
(10) Pub. No.: US 2007/0115605 A1
(43) Pub. Date: May 24, 2007

(54) Method and arrangement for shielding a component against electrostatic interference

(75) Inventors: Ari Pekkarinen, Laukaa (FI); Pasi Saukonoja, Parantala (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: NOKIA CORPORATION, Espoo (FI)

(21) Appl. No.: 10/582,833

(22) PCT Filed: Nov. 24, 2004
(86) PCT No.: PCT/FI04/50176

§ 371 Date: Jun. 14, 2006

(30) Foreign Application Priority Data
Dec. 15, 2003 (FI) 20035238

(51) Int. Cl. H05F 3/02; H05F 3/00; H01H 47/00

(52) U.S. Cl. 361/220

(57) ABSTRACT

The invention relates to an apparatus and arrangement for shielding a component, particularly a semiconductor component, against electrostatic discharge. The semiconductor component according to an embodiment of the invention comprises an electroconductive element, for which there is arranged at least one outlet so that the electroconductive element is groundable through said outlet for shielding the semiconductor component against electrostatic pulses.

The invention relates to an apparatus and arrangement for shielding a component, particularly semiconductor component, against electrostatic discharge.

Semiconductors represent type p and type n. Generally semiconductors comprise a junction surface between two different types of semiconductors, such as a pn-junction, a pnp-junction or an npn-junction. In semiconductor junctions, the p-side has a negative charge, and the electron-free holes serve as charge carriers. The n-side has a positive charge, and the free electrons serve as charge carriers. The electric charge of a hole is positive and equal in magnitude, but of the opposite sign than the electron charge. In semiconductor material, the flow direction of the holes is opposite to the flow direction of the electrons. When a forward current is induced in a semiconductor, so that the p-side is arranged at a higher potential and the n-side is arranged at a lower potential, electrons flow to the junction areas from the n-side and holes from the p-side. Free holes and electrons are annihilated, i.e. the electrons fill the free holes. This kind of transfer of electrons from a high-energy state to a lower-energy state releases energy.

A semiconductor is typically formed of a solid chemical ingredient that is electroconductive only in certain conditions. Elemental semiconductors are for example antimony (Sb), arsenic (As), boron (B), carbon (C), germanium (Ge), selenium (Se), silicone (Si), sulfur (S) and tellurium (Te). Among these, the best-known is silicone, and it constitutes the basis for most integrated microcircuits. General semiconductor compounds contain gallium arsenide (GaAs), indium antimonide and oxides of most metals. Among these, gallium arsenide is widely used in silent, highly amplified amplifiers of weak signals. The properties of semiconductors depend on the impurities added therein, i.e. of interfering atoms that increase the quantity of conducting electrons or holes. Semiconductor components are for example transistors, integrated microcircuits, diodes, light emitting diodes and various surface junction semiconductors.

Semiconductors and semiconductor components are sensitive to electrostatic discharge (ESD). Electrostatic discharge typically occurs when two different materials, one of which has a positive charge and the other a negative charge, are set in mutual contact. The positively charged material has an electrostatic charge.

When this kind of electrostatic charge gets into contact with a given other material, the charge is transferred, and an electrostatic discharge is created.

In an electrostatic discharge, a remarkable quantity of thermal energy is released. If the electrostatic charge is discharged on a sensitive electric device or component, the heat released in the discharge can melt, vaporize or otherwise damage sensitive components. Electrostatic discharge can damage the device components, so that the device still works, but in some of its parts or functions, there occur errors or irregularities deviating from the normal operation. This kind of hidden effects are very difficult to observe, and they remarkably shorten the working life of the device. Many electronic devices are sensitive even to low-voltage electrostatic discharge. Therefore manufacturers tend to avoid electrostatic discharge throughout the whole manufacturing process: during the manufacturing, testing, transportation and processing steps. In addition, the products and their elements can be subjected to electrostatic discharge when using the products, wherefore the shielding of sensitive components should be taken care of also in the final product.

Sensitive electronic products, devices and components are typically packed in materials that shield the products against harmful charges. A product can be shielded mechanically by insulating it against possible external charges. Typically the insulation is carried out by leaving an insulation clearance between the product and the shielding element, said clearance being for example an insulating clearance of air. In practice, the product is put for instance in a thick plastic bag, so that an insulating layer of air is arranged between the product and the bag. This kind of insulation is generally not suited for products during their use, because the cover and the insulating layer may disturb the use or make it cumbersome, or it may even prevent some functions from being performed.

Another generally used shielding method is a metal box installed around the component to be protected. A metal box provides a good and reliable shielding against electrostatic discharge. The same metal box can typically be used as an electromagnetic shielding, particularly in the surroundings of a processor, and for devices that are subjected to radio voltages or high voltages, or to high and fast frequencies. Typically shielding metal boxes are heavy and expensive. Metal boxes take up a lot of space, wherefore especially in small devices, their size and weight may turn out to be decisive factors. In addition, the installation of metal boxes in a product or a device always constitutes an extra part of the assembly step. Installation is precise work and makes the assembly more difficult. In addition, a metal box that is reliable as such is not a feasible protection for instance for a light emitting diode, because the light emitted by a light emitting diode cannot permeate the protecting metal box. Often a metal box is a slightly too robust and also expensive solution, because it always requires an extra assembly step.

One objective of the invention is to shield a semiconductor component properly and reliably against electrostatic discharge. Another objective of the invention is to shield semiconductors against electrostatic discharge in an economical way. Yet another objective of the invention is to realize the shielding of a semiconductor component in a simple fashion. Yet another objective of the invention is to keep the structure and assembly of the final product simple. In addition, an objective of the invention is to prevent drawbacks occurring in arrangements according to the prior art.

These objectives are achieved so that in the semiconductor component, there is permanently integrated an electroconductive element, and for said electroconductive element, there is provided an outlet through which the semiconductor component can be grounded, for shielding the semiconductor component against electrostatic pulses.

The invention is characterized by what is set forth in the independent claims. Other embodiments of the invention are described in the dependent claims of the invention.

A semiconductor component according to an embodiment of the invention comprises an electroconductive element, for which element there is provided at least one outlet from the component, so that the electroconductive element can be grounded via the outlet for shielding the semiconductor component against electrostatic pulses. The electroconductive element can be integrated as a permanent part of the semiconductor component, under the cover element of the semiconductor component, inside the cover element; or on top of the cover element of the semiconductor component, outside the cover element. In a method according to an embodiment of the invention for shielding a semiconductor component against electrostatic pulses, an electroconductive element is integrated in the semiconductor component, and for the integrated electroconductive element there is arranged at least one outlet, so that the electroconductive element can be grounded via the outlet. A device according to the embodiment of the invention comprises a mounting tray, components and a semiconductor component, where an electroconductive element is integrated, and the electroconductive element is provided with at least one outlet that is grounded to the ground plane of the mounting tray.

The electroconductive element of a semiconductor component according to the invention can be sheet-like, for example a metal sheet to be positioned on top of the component cover, or loop-like, for example a thin metal loop that encircles the topmost surface of the component cover element. According to an embodiment, the electroconductive element is grounded, when the component is installed in a given product, device or structure. From the electroconductive element of the semiconductor component, there is arranged an outlet, so that said outlet can be connected to the ground plane of the structure to be installed, for example to the ground plane of a circuit board. Thus the electrostatic pulses coming to the semiconductor component are conducted to the electroconductive element according to an embodiment of the invention, from where they are further conducted to the ground plane. Thus the semiconductor component itself remains undamaged.

By means of the semiconductor component according to embodiments of the invention, the component can be shielded in a reliable, simple and economical fashion, without any extra structural elements. This is useful also in that in the assembly step, it is not necessary to separately install shielding elements for the components. Particularly semiconductors that are sensitive to electrostatic pulses can thus be shielded one by one, and it is not necessary to take care of their shielding separately for instance in the planning or production steps. Consequently, the use of shielded components according to an embodiment of the invention makes planning easier and improves the quality of the final product.

Let us now observe embodiments of the invention in more detail, with reference to the appended drawings, where

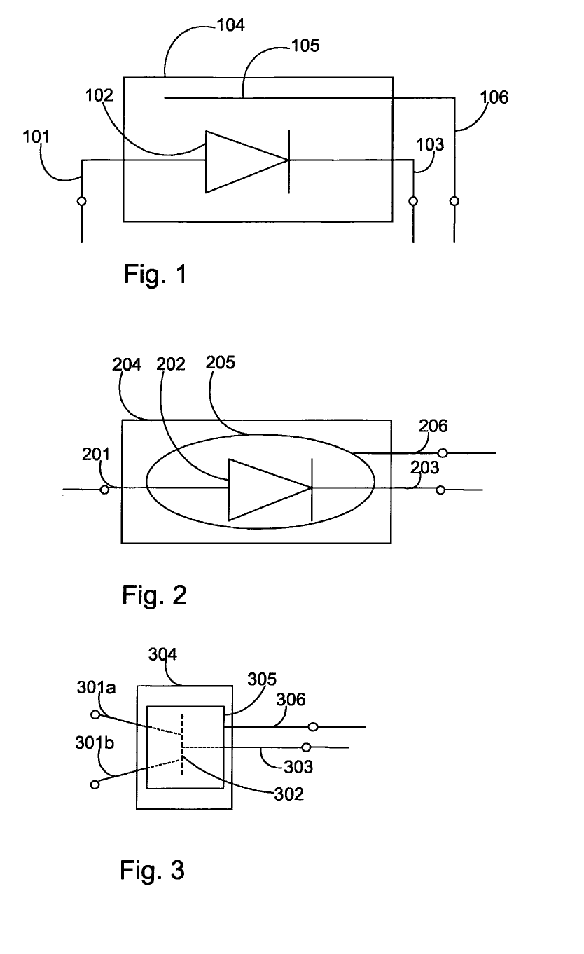

FIG. 1 illustrates an arrangement according to an embodiment of the invention, seen from the side,

FIG. 2 illustrates an arrangement according to an embodiment of the invention, seen from the top, and

FIG. 3 illustrates an arrangement according to an embodiment of the invention, seen from the top.

Like numbers for like parts are used in the drawings. The arrangements shielding the components against electrostatic pulses, illustrated in connection with embodiments of the invention, are suited to be used for shielding all kinds and different types of semiconductors and semiconductor components, such as transistors, integrated microcircuits, diodes, light emitting diodes, photovoltage diodes and various surface-junction semiconductors. Arrangements according to the embodiments of the invention can be applied for all types of semiconductors and for various semiconductor components, according to the applications at hand. The embodiments of the invention do not in any way restrict the use of the shielding arrangement for a semiconductor component that is illustrated as an example in the shielding arrangement according to an embodiment.

FIG. 1 illustrates, according to an embodiment of the invention, a diode 102 shielded against electrostatic discharge, seen from the side. The diode 102 has two electrodes, an anode 101 and a cathode 103. Most diodes 102 are made of semiconductor materials, such as silicone, germanium or selenium. A basic property of the diode 102 is its tendency to conduct current only in one direction. When the cathode 103 has a negative charge in comparison with the anode 101, and the voltage difference therebetween surpasses a given threshold voltage, the current flows through the diode 102.

The diode 102 illustrated in FIG. 1 is typically encased in a box 104. Generally semiconductor components are encased. The box 104 can be manufactured for instance by casting. Typically the box 104 is made of hard plastic, such as epoxy. According to an embodiment of the invention, above the diode 102 there is arranged an electroconductive element 105. When the diode 102 is soldered to the circuit board, the circuit board shields the diode 102 against electrostatic pulses coming from the direction of the circuit board. However, that side of the diode 102 that faces away from the circuit board is still susceptible to external electrostatic discharges. That side of the diode 102 that is, during the installation, pointed upwardly or outwardly from the mounting tray, is according to an embodiment of the invention shielded by means of an electroconductive element 105. The electrostatic pulses entering the structure are conducted to the electroconductive element 105, and they cannot proceed as far as to the component 102. Thus the sensitive semiconductor component 102 is not damaged.

According to an embodiment of the invention, from the electroconductive element 105 there is arranged an outlet to the component. The diode 102 according to an embodiment of the invention is provided with one or several extra outlets for connecting the electroconductive element 105 to the ground plane of the circuit board. Thus the electrostatic pulses coming to the electroconductive element are conducted to the ground plane. An arrangement according to an embodiment of the invention also results in at least one extra solder joint on the printed circuit board.

The electroconductive element of the semiconductor component according to embodiments of the invention is arranged above the semiconductor material of the component. The electroconductive element can be arranged inside the semiconductor cover element or outside the cover element. Generally a semiconductor component must be mounted in a predetermined position defined by its terminal pins or leads. When a semiconductor component is being mounted for instance on a circuit board, a substrate or a film, said mounting tray forms a shielding on the mounting tray side of the semiconductor component, which side is typically called the bottom side. However, the opposite, top side of the semiconductor component is still susceptible to electrostatic pulses or discharges coming from outside. Thus the top side of the semiconductor component means that side of the component that faces openly outwards, away from the mounting tray, when the semiconductor component is mounted on its mounting tray.

Diodes can be used as a rectifier, restrictor, voltage controller, switch, modulator, mixer, demodulator and oscillator. Some diodes generate direct current, when hit by visible light, infrared or ultraviolet energy. Such diodes are photovoltage diodes, i.e. solar cells. Some diodes used generally in electronic and computer devices emit visible light or infrared energy, when the current permeates the diode. Such light emitting diodes are used in several lighting applications, such as for instance in illuminating displays, number and address plaques, watches, electronic calculators, car speedometers and signal lights.

FIG. 2 is a top-view illustration of an arrangement according to the invention for shielding a semiconductor component 202, such as for instance a light emitting diode, against external electrostatic pulses. The semiconductor has an inlet or feed point 201 and an outlet point 203. Here the electroconductive element shielding the semiconductor 202 is loop-like in structure. The loop-like structure 205 can conform to the shape of the cover element 204 of the semiconductor 202, and it can be for example a square rounded at the edges, a circle or an oval, such as in FIG. 2. When seen from the top, the loop-like structure essentially surrounds or encircles the semiconductor component 202 to be shielded that is located underneath said structure. The loop-like structure can be induced electrochemically or chemically in the cover element 204 of the semiconductor component 202, outside or inside said cover element. The loop structure 205 can be realized by means of film. The film can be for example such that the permeable film is encircled by an electroconductive loop element. A film structure that is larger than the loop element proper makes it easier to attach the small film precisely in place. The loop-like electroconductive element 205 has at least one outlet 206, through which the electroconductive element 205 can be connected to the ground plane of the mounting tray in order to conduct external electrostatic pulses via the electroconductive element 205 to said ground plane. The outlet 206 for grounding can be realized in similar ways as the electroconductive element 205.

A loop-structured electroconductive element 205 according to an embodiment illustrated in FIG. 2 is used for example when the desired structure should be as light-weight as possible. The embodiment of FIG. 2 is feasible also in a case where the semiconductor component 202 left underneath he electroconductive element 205 cannot be covered by the electroconductive element 205. For instance a light emitting diode can be shielded by a loop-structured electroconductive element 205 according to the embodiment illustrated in FIG. 2, because thus the light emitted by the light emitting diode still has free access in the direction of the shielding. A metal sheet cannot be positioned on top of a light emitting diode without altering, preventing or disturbing the proceeding of light in the direction in question. Also from the point of view of the operation of a photovoltage diode, i.e. in order to make it generate direct current, the visible light, infrared or ultraviolet energy must hit the photovoltage diode. In the shielding of a photovoltage diode, there is according to an embodiment used a loop-structured electroconductive element that does not cover the component to be shielded, and consequently does not prevent radiation from proceeding to the photovoltage diode to be protected. According to an embodiment, on top of the semiconductor component there is arranged a film that can be permeated only by a certain type of radiation with a certain wavelength. The film according to an embodiment has an electroconductive layer that shields the semiconductor component located underneath it against electrostatic pulses, but is permeable for example to visible light, infrared or ultraviolet radiation. Thus the radiation has free access to proceed to the semiconductor component or out thereof. The electroconductive layer can be diffused so thin that light penetrates the generated electroconductive layer for nearly a hundred percent. A permeable, electroconductive layer can be produced for example by vaporizing a thin metal layer on the film surface.

FIG. 3 is a top-view illustration of a transistor 302 that is shielded against electrostatic pulses according to an embodiment of the invention. Transistors typically have a three-layered structure composed of two different semiconductor types. There are transistors of the pnp type and transistors of the npn type. The innermost semiconductor layer of the transistor 302 serves as a control electrode. A slight change in the current or voltage in the control electrode results in an extensive, rapid change in the whole current passing through the component 302. The proceeding direction of the current is, depending on the type of the transistor 302, the direction of the outlet 301b or the direction of the outlet 303, when the transistor is in electroconductive state.

In the embodiment illustrated in FIG. 3, on top of the transistor there is arranged a planar, electroconductive metal sheet 305, and the component 302 left underneath said metal sheet is represented by dotted lines. The electroconductive metal sheet 305 according to an embodiment of the invention constitutes a permanent part of the component to be shielded, in this case of the transistor 302. The electroconductive metal sheet 305 can be integrated inside the component cover element, or outside, on top of the cover element. The electroconductive metal sheet 305 can be induced chemically or electrochemically, or a metal film can be attached to the component cover element, which film functions as the electroconductive element according to the invention. The electroconductive metal sheet 305 has at least one outlet 306, through which the electroconductive metal sheet 305 can be connected to the ground plane. Typically the electroconductive metal sheet 305 shielding the component is connected to the ground plane of that mounting tray in which the component itself is attached by soldering.

Transistors typically function as switches, and their mode can be altered from conductive to non-conductive several times per second. At present, for instance in computers there are employed a lot of efficient metal oxide semiconductors, where two transistors are used per each gate. In addition, integrated circuits use very small transistors and other circuit elements. An integrated circuit is a semiconductor sheet, for example a silicone crystal, provided with thousands or millions of small resistors, condensators and transistors. Extremely tiny transistors of integrated circuits are not manufactured by combining different types of semiconductor materials, but by diffusing a suitable concentration of acceptors and donor impurities in the various layers of the silicone crystal. Thus an electroconductive element according to the embodiments of the invention for shielding a component can be for example diffused on top of said silicone crystal, or to the layers located above the semiconductor materials diffused therein, in the same step where also the semiconductor materials are diffused. Moreover, it is possible to induce an electroconductive element of a certain size and shape chemically or electrochemically as part of the component. As the electroconductive element, there can also be used a film to be connected as part of the component to be diffused, said film including an electroconductive metal element. Integrated circuits are used in amplifiers, oscillators, timers, calculators, computer memories and microprocessors.

1. A semiconductor component, wherein the component comprises an electroconductive element provided with at least one outlet, so that the electroconductive element is groundable via an outlet for shielding the semiconductor component against electrostatic pulses.

2. A semiconductor component according to claim 1, wherein in structure, the electroconductive element is a planar sheet.

3. A semiconductor component according to claim 1, wherein the electroconductive element is a thin loop structure.

4. A semiconductor component according to claim 1, wherein the electroconductive element forms a permanent, integrated part of the semiconductor component.

5. A semiconductor component according to claim 4, wherein the electroconductive element is placed underneath the cover element of the semiconductor component, inside said cover element.

6. A semiconductor component according to claim 4, wherein the electroconductive element is placed on top of the cover element of the semiconductor component, outside said cover element.

7. A semiconductor component according to claim 1, wherein the electroconductive element is induced in the cover element of the semiconductor component either chemically or electrochemically.

8. A method for shielding a semiconductor component against electrostatic pulses, comprising intentegating an electroconductive element in the semiconductive component, and providing at least one outlet for the integrated electroconductive element, so that the electroconductive element is groundable through the outlet.

9. A method according to claim 8, wherein in the semiconductor component, there is integrated an electroconductive, planar element.

10. A method according to claim 8, wherein in the semiconductor component, there is integrated an electroconductive, loop-shaped element.

11. A method according to claim 8, wherein the electroconductive element is integrated as a permanent part of the semiconductor component.

12. A method according to claim 11, wherein the electroconductive element is integrated underneath the cover element of the semiconductor component, inside said cover element.

13. A method according to claim 11, wherein the electroconductive element is integrated on top of the cover element of the semiconductor component, outside said cover element.

14. A method according to claim 8, wherein the electroconductive element is induced in the cover element of the semiconductor component either chemically or electrochemically.

15. An apparatus including a mounting tray and components, wherein a component of the components comprises a semiconductor component, in which there is integrated an electroconductive element, and where the electroconductive element is provided with at least one outlet that is grounded to a ground plane of the mounting tray.

16. Apparatus for shielding a semiconductor component against electrostatic pulses, comprising:
means for integrating an electroconductive element in the semiconductor component; and
means for providing at least one outlet for the integrated electroconductive element, so that the electroconductive element is groundable through the outlet.

17. The apparatus of claim 16, wherein in the semiconductor component, there is integrated an electroconductive, planar element.

18. The apparatus of claim 16, wherein in the semiconductor component, there is integrated an electroconductive, loop-shaped element.

19. The apparatus of claim 16, wherein the electroconductive element is integrated as a permanent part of the semiconductor component.

20. the apparatus of claim 16, wherein the electroconductive element is integrated underneath the cover element of the semiconductor component, inside said cover element.
